(19) United States
(12) Patent Application Publication
(10) Pub. No.: US 2010/0168933 A1
(43) Pub. Date: Jul. 1, 2010

(54) TURRET MOUNTED COMPACT TOOL CARRIER

(75) Inventor: David A. Rorabaugh, Perry, OK (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(73) Assignee: The Charles Machine Works, Inc., Perry, OK (US)

(21) Appl. No.: 11/916,932

(22) PCT Filed: Jun. 9, 2006
(86) PCT No.: PCT/US2006/022821

§ 371 Date: Dec. 7, 2007

Related U.S. Application Data
(60) Provisional application No. 60/689,245, filed on Jun. 10, 2005.

(51) Int. Cl. B60P 1/00; G06F 19/00

(52) U.S. Cl. 701/2; 414/680; 414/694

(57) ABSTRACT

A turret mounted compact tool carrier. The tool carrier is a small, ride-on machine. The tracked substructure is connected to the upper section of the machine by a 360 degree turret, which allows the upper section of the machine to face any direction, independent of the direction of the tracks. The distance between the tracks is adjustable, depending on particular application. An operator rides on a platform at the back of the upper section, while a work tool is connected to the front of the upper section. Thus, the operator always maintains a line-of-sight parallel to the direction of operation of the work tool, resulting in a greater degree of safety. The machine has lift arms that are extendable, allowing the work tool to be pushed without operating the tracks. These features give the tool carrier the ability to fully operate in narrow spaces and with limited operation of the tracks, resulting in more efficient use and less ground damage than traditional skid loaders.

### CROSS REFERENCE TO RELATED APPLICATION

This application claims the benefit of PCT Application Number PCT/US2006/022821, filed Jun. 9, 2006, which claims the benefit of U.S. Provisional Application No. 60/689,245, filed Jun. 10, 2005, the contents of which are incorporated fully herein by reference.

### FIELD OF THE INVENTION

The present invention relates to the field of compact utility vehicles and more particularly to a ride-on turret mounted tool carrier.

### SUMMARY OF THE INVENTION

The present invention is a compact tool carrier machine comprising a drive frame undercarriage, an upper frame, a turret, a lift arm apparatus, a tool adaptor, and an operator station. The upper frame has a front end and a back end. The turret is adapted to rotatably connect the upper frame to the undercarriage. The lift arm apparatus has a first end and a second end. The first end of the lift arm apparatus is pivotally connected to the upper frame at a pivot point. The tool adaptor is attachable to the second end of the lift arm apparatus. The operator station is supported by and substantially centered on the back end of the upper frame. The operator station comprises a platform. The platform is adapted to allow operation of the machine while standing on the platform.

### BRIEF DESCRIPTION OF THE DRAWINGS

FIG. 1 is a side view of a compact work machine built in accordance with the present invention.

FIG. 2 is a rear view of the machine in FIG. 1 showing an upper frame rotated to the side.

FIG. 3 is a perspective view of a turret apparatus for use with the present invention.

FIG. 4 is a cut-away perspective view of an extension apparatus, for use with the present invention.

FIG. 5 is a cut-away side view of the extension apparatus in FIG. 4.

FIG. 6 is a rear view of a tool adaptor with a pivoted plate adaptor.

### DESCRIPTION OF THE INVENTION

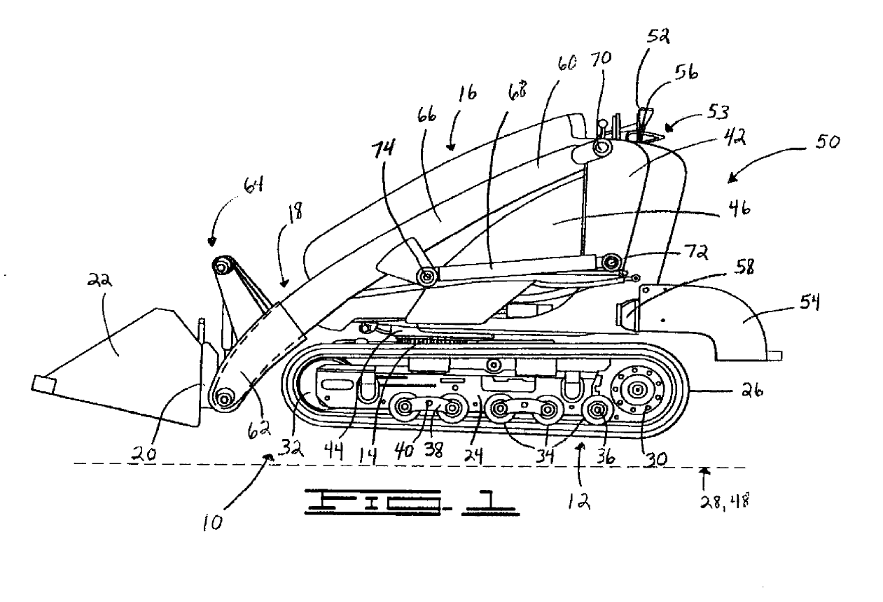

Turning now to the drawings in general and FIG. 1 in particular, there is shown a compact tool carrier with a turret mounted upper structure in accordance with the present invention. The tool carrier, designated by reference numeral 10, comprises a drive frame undercarriage 12, a turret assembly 14, an upper frame 16, and a lift arm apparatus 18. The turret assembly 14 rotatably connects the drive frame undercarriage 12 with the upper frame 16. The lift arm apparatus 18 is adapted with a common attachment plate or tool adaptor 20 for connection to any of a plurality of work tools. In a preferred embodiment shown in FIG. 1, the work tool 22 comprises a bucket.

The drive frame undercarriage 12 comprises a track frame substructure 24 and a plurality of drive tracks 26 mountable on the track frame substructure. Alternatively, the drive frame undercarriage 12 may be a wheeled unit. The track frame substructure 24 and the drive tracks 26 define an undercarriage axis of orientation 28. The undercarriage axis of orientation 28 is parallel to the lengthwise orientation of the drive tracks 26. The tool carrier 10 will generally travel in a direction parallel to the undercarriage axis of orientation 28 when the drive tracks 26 are operating at identical speeds.

Each of the plurality of drive tracks 26 is preferably movably attachable to the track frame substructure 24 and supported on a plurality of support members 30 and 32. The support members 30 and 32 are rotatably secured to the substructure 24. Preferably, the support members 30 and 32 comprise a rear support member 30 and a front support member 32. The rear support member 30 is a drive sprocket that engages any of the plurality of drive tracks 26. The front support member 32 is an idler, rotatably supporting to the drive tracks 26.

With continued reference to FIG. 1, each of the plurality of drive tracks 26 is further supported by a plurality of rollers 34. Preferably, the plurality of rollers 34 are connected to the frame substructure 24 to provide resistance to force exerted on the drive tracks 26 by the ground. The rollers 34 are disposed on the track frame substructure 24 along a length of the tracks 26. The rollers 34 may also be disposed on both the inside and outside of the track frame substructure 24 to provide additional support. The rollers 34 may be connected to the track frame substructure 24 in the center to rotate on an axle 36. Alternatively, the rollers 34 may be paired by a connector bar 38. Preferably, the connector bar 38 is attached by a connector bar bolt 40 to the track frame substructure 24. This configuration allows paired rollers 34 to pivot around the connector bar bolt 40. In this configuration, the connector bars 38 and rollers 34 commonly referred to as bogie rollers provide a smoother ride across rough ground terrain.

A preferred embodiment of the upper frame 16 is illustrated in FIG. 1. The upper frame 16 has a front end and a back end 53. The upper frame 16 comprises a support frame 42, a turret mount 44, an engine (not shown) supported within an engine casing 46. The support frame 42 defines an upper frame axis of orientation 48. The upper frame axis of orientation 48 is essentially the lengthwise centerline of the upper frame 16. The turret mount 44 connects the upper frame 16 to the turret assembly 14.

The engine rotates hydraulic pumps that provide power to the tool carrier 10. The engine and hydraulic pumps are housed within the engine casing 46. The engine casing 46 protects the engine, pumps, and other machine components from external damage while protecting persons and objects near the tool carrier 10 from hazards due to operation of the engine.

The tool carrier 10 further comprises an operator station 50, supported on the upper frame 16, having controls 52 for operating the machine. The operator station 50 is preferably substantially centered on the back end 53 of the upper frame 16. In one embodiment, the operator station 50 comprises an operator platform 54 and a control panel 56 comprising the controls 52. The control panel 56 is preferably in a position that allows an operator to access the control panel 56 while walking behind or along the side of the tool carrier 10 or while standing on the platform 54. The operator platform 54 provides a stable place for an operator to stand, providing easy access to the control panel 56. More preferably, the operator platform 54 is attached to the support frame 42 with a rubber mount 58. The rubber mount 58 absorbs shock associated with operation of the tool carrier 10.

The control panel 56 controls key elements of the tool carrier 10. In a preferred embodiment, from the control panel 56, an operator can start, stop and adjust the engine, and change the speed of the drive tracks 26 to change the velocity and direction of the tool carrier 10. The control panel 56 also controls the orientation of the turret assembly 14, manipulates the lift arm apparatus 18, and controls operation of the work tool 22.

Alternatively, as one skilled in the art would appreciate, the compact tool carrier 10 can be operated by way of a remote control. In this embodiment control panel 56 could be contained within a remote control housing that would be carried or positioned by an operator and at a discrete distance from the tool carrier 10. The operator could then operate tool carrier 10 without the need to maintain physical contact with the machine. Control signals would be carried via radio signals, a tethered connection, or other transmission method to the unit. The tool carrier 10 would respond appropriately according to control signals.

The lift arm apparatus 18 pivotally attaches to the support frame 42. The lift arm apparatus 18 has a first end 60 and second end 62. The first end 60 is pivotally connected to the support frame 42. The second end 62 is connected to the tool adaptor 20. The second end 62 of the lift arm apparatus 18 is preferably located proximate the front end of the upper frame 16. The lift arm apparatus 18 comprises a telescoping extension apparatus 64, a plurality of lift arms 66 and a plurality of lift cylinders 68. As depicted in FIG. 1, the lift arms 66 are connected to the support frame 42 at a pivot connection 70. In a preferred embodiment, the pivot connection 70 is aft of the turret assembly 14, proximate the operator station 50. In the configuration, the tool adaptor 20 and the work tool 22 are disposed on a side of the turret 14 opposite from the operator station 50. The extension apparatus 64, yet to be described, is adapted to extend the work tool 22 without operation of the drive tracks 26 for increased reach and versatility.

The plurality of lift cylinders 68 are adapted to raise and lower the plurality of lift arms 66. The plurality of lift cylinders 68 are hydraulically powered by the engine and controlled at the control panel 56. Each lift cylinder comprises a first end 72 and a second end 74. Each of the lift cylinders 68 is pivotally connected at the first end 72 to the support frame 42 and at the second end 74 to the lift arms 66. When pressure in the lift cylinders 68 is increased, the distance between the first end 72 and the second end 74 increases. The extension of the lift cylinders 68 causes the lift arms 66 to be raised pivotally around the pivot connection 70.

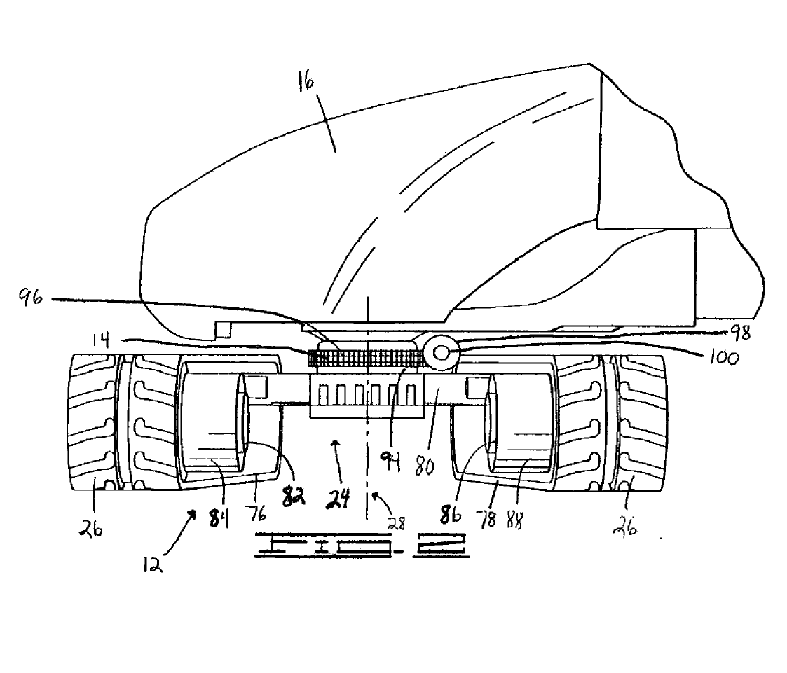

Referring now to FIG. 2, shown therein is a preferred embodiment for the drive frame undercarriage 12. The track frame substructure 24 comprises a left track substructure 76, a right track substructure 78, and a center main substructure 80. Preferably, the left substructure 76 comprises a left drive motor 82, used to rotate a left rear support member 84. The right substructure 78 comprises a right drive motor 86, used to rotate a right rear support member 88. The speed of the motors 82 and 86 may be adjusted separately, allowing for adjusting the speed of the drive tracks 26 and steering of the tool carrier 10.

The main substructure 80 connects the left substructure 76 and the right substructure 78. The main substructure 80 comprises an adjustment mechanism (not shown) that adjusts the distance between the left substructure 76 and the right substructure 78. This width adjustment is known to those skilled in the art and will only be explained briefly here. One preferred method of track width adjustment includes using a tubular structure where one set of tubes fit snuggly inside a second set of tubes. These tubes maintain the structural tie between the tracks 26. Typically a cylinder is attached between the left substructure 76 and the right substructure 78 and is used to push and pull said substructures to produce a wider or narrower track width. In this embodiment, the tracks 26 can be narrowed to allow the tool carrier 10 to fit into narrow spaces. Alternatively, the tracks 26 can be widened to give the tool carrier 10 increased stability. Stability is an important consideration to the tool carrier 10 in that the machine can rotate the work tool 22 to one side. This rotation may cause an instability when the machine is configured with very narrow tracks. Thus, the machine may have load sensors (not shown) contained within lift arms 66 or lift cylinders 68. The load sensors can sense the load on the work tool 22. The turret assembly 14 may also have a rotational sensor which senses rotational position of the turret assembly 14 relative to the undercarriage 12. The track width adjustment may have a width adjustment sensor to indicate track width. The tool carrier 10 might also contain a sensor micro-processor or logic sensor that receives load sensor information or rotational sensor information or track width sensor information and controls or limits rotational speed and for angle or rotation to prevent the upper frame 16 from rotating to a position of instability. Additionally, the tool carrier 10 might have an inclination sensor that could provide additional input to stability decisions.

With continued reference to FIG. 2, the turret assembly 14 is shown in a configuration where the undercarriage axis of orientation 28 is nonparallel to the upper frame axis of orientation 48. One skilled in the art will note the advantages of this. The operator's platform 54 is able to extend beyond the drive tracks 26 during rotation for more precise placement of the work tool 22. In confined spaces where there is a limitation on where the drive tracks 26 may be positioned, operation of the turret assembly 14 allows movement of work from one side of the tool carrier 10 to another or from the front to the rear without requiring operation of the drive tracks 26. This is particularly advantageous, for example, when dumping material from a bucket or placing material carried with a fork or grapple. Additionally the precise placement of the work tool 22 can be more easily attained using the combination of rotation of the upper frame 16 and operation of the extension apparatus 64 than with placement resulting from movement of the tracks 26.

The turret assembly 14 comprises a turret frame 94, a sprocket 96, a worm gear 98, and a turret motor 100. The turret frame 94 is preferably attached to the drive frame undercarriage 12 on the center main substructure 80. More preferably, the turret frame 94 is attached to the main substructure 80 such that the turret assembly 14 is located toward a front end of the track undercarriage 12, forward of a center point of the undercarriage. The center point may be defined as a point equidistant from the front end and the back end of the undercarriage 12. In this location, the turret 14 is located forward of the center of gravity of the tool carrier 10.

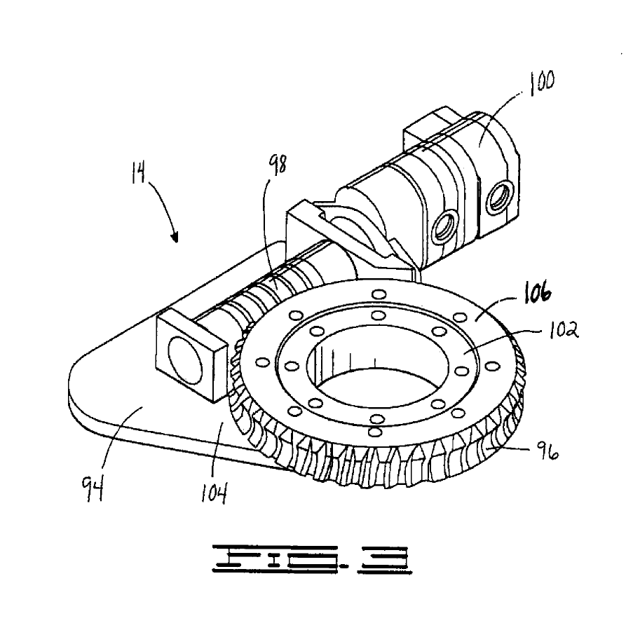

A preferred embodiment of the turret assembly 14 is shown in FIG. 3. The turret frame 94 comprises a turret sleeve 102 and a lower stationary 104. The sprocket 96 rotationally attaches to the turret sleeve 102. The sprocket is fixed to an upper stationary surface 106, which is bolted to the upper frame 16. Thus, as the sprocket 96 is rotated by the worm gear 98, the entire upper frame 16 rotates relative to the undercarriage 12. The turret assembly 14 allows 360 degree rotation. One skilled in the art will appreciate that this will allow operation of the tool carrier 10 when the undercarriage axis of orientation 28 is nonparallel to the upper frame axis of orientation 48.

The worm gear 98 is rotated by the turret motor 100. As the worm gear 98 rotates, threads on its rotational surface interact with the threads on the surface of the sprocket 96. Preferably, the turret motor 100 is hydraulic and may be powered by operation of the engine. Alternatively, one skilled in the art could envision turret assembly 14 containing a rotation axis that is powered by a cylinder, in which case the rotational angle would be limited by rotational stroke. One skilled in the art could envision alternative mechanisms such as a spur gear or bevel gear to provide rotational action.

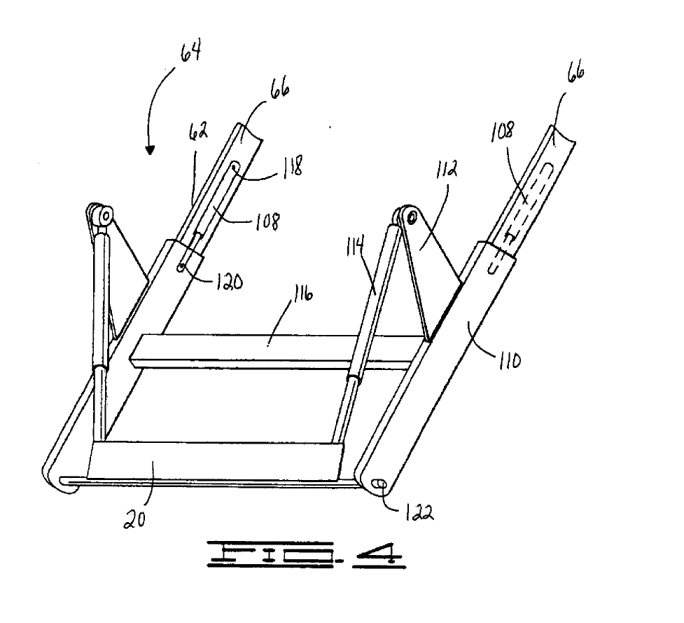

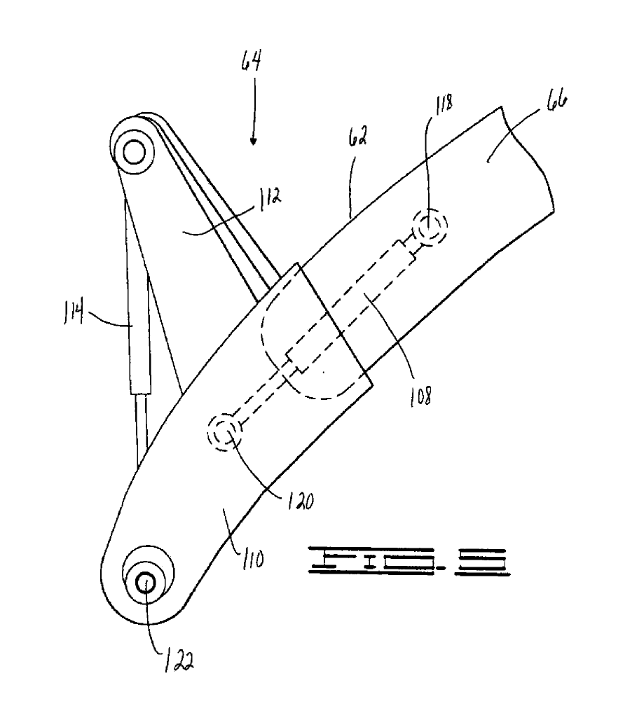

Turning now to FIGS. 4 and 5, the extension apparatus 64 positioned at the second end 62 of the lift arm 66 is shown. The extension apparatus 64 comprises extension cylinders 108, first and second extension arms 110, support arms 112, tilt cylinders 114, and a stabilizing cross member 116. The extension cylinders 108 each have a first end 118 and a second end 120. The first ends 118 of the extension cylinders 108 are connected to the lift arms 66. The second ends 120 are attached to the extension arms 110.

Each of the extension arms 110 comprise a sleeve that is adapted to receive the lift arms 66. Preferably, the extension cylinders 108 are hydraulically powered by the engine and controlled from the control panel 56. As the pressure in the extension cylinders 108 is increased, the distance between the first end 118 and the second end 120 increases. The second ends 120 push the extending arms 110 along the lift arms 66, away from the pivot connection 70. Preferably, when the extension cylinders 108 reach a maximum length, there will be enough remaining contact between the extension arms 110 and the lift arms 66 to provide the extension apparatus 64 with stability. More preferably, the extension arms 110 are caused to move along the lift arms 66 by way of a stabilizing track or other common telescoping mechanisms.

The support arms 112 are mounted on the extension arms 110 and are pivotally attached to the tilt cylinders 114. The tilt cylinders 114 adjust the orientation of the tool adaptor 20, by shortening or lengthening a distance between the support arms 112 and the tool adaptor 20. As the tilt cylinders 114 change length, the tool adaptor 20 is pivotally rotated about an adaptor connector 122. Preferably, when the tilt cylinders 114 shorten, the tool adaptor 20 tilts back relative to the loader arm apparatus 18. The cross member 116 attaches to the extension arms 110 to provide additional stability. One skilled in the art will recognize other means of extending the reach and the orientation of the tool adaptor.

Those skilled in the art will appreciate the implications of the extension cylinders 108 and tilt cylinders 114 in tandem with the turret assembly 14. The tool carrier 10 is able to utilize the extension apparatus 64 to extend a work tool parallel to the upper frame axis of orientation 48. This may be particularly advantageous when the turret 14 is rotated such that the upper frame axis of orientation 48 is non-parallel to the undercarriage axis of orientation 28 as previously described.

When the turret 14 is rotated in this manner, the work tool 22 and the operator station 50 extend beyond opposite sides of the tracks 26. In this configuration, the operator station 50 counterbalances the weight of the work tool 22. One skilled in the art will appreciate that this gives the operator of the tool carrier 10 a clear line-of-sight (not shown) enabling safe and proper operation of the lift arm apparatus 18, yet to be described, and the work tool 22. Positioning of the turret assembly 14 on the upper frame 16 towards the work tool 22 offsets the weight of the attachment and the load for improved weight distribution on the tracks 26 when a load is being carried or lifted and when the upper frame axis of orientation 48 is nonparallel to the undercarriage axis of orientation 28. Maintaining the line-of-sight along the upper frame axis of orientation 48 with the lift arm apparatus 18 will limit accidents and loss of productivity due to errors in the operator's perspective. Alternatively, one skilled in the art could envision that the turret assembly 14 could be positioned in a non centered position. If the turret assembly 14 were positioned closer to the operator, the operator would experience less tangential force while operating the turret assembly 14.

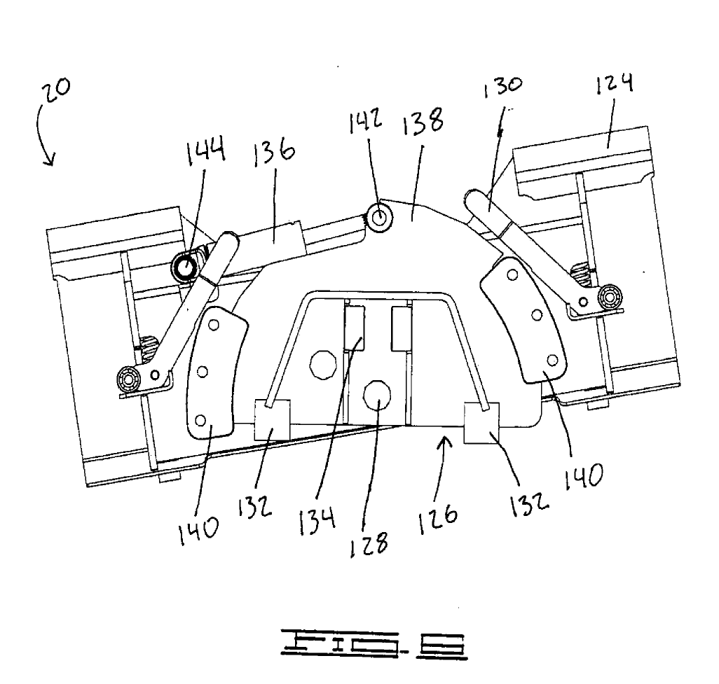

With reference now to FIG. 6, a preferred embodiment of the tool adaptor 20 is shown in additional detail. The tool adaptor 20 comprises a plate adaptor 124 and a tool pivot assembly 126. The plate adaptor 124 is adapted for easy attachment to any of a plurality of work tools 22. The tool pivot assembly 126 is adapted to pivot the work tool 22 and the plate adaptor 124 about a pivot pin 128. The plate adaptor 124 comprises a plurality of release latches 130. Pivotal motion of the plate adaptor 124 is restricted by operation of the plurality of release latches 130.

The tool pivot assembly 126 comprises a plurality of bosses 132, a tilt cylinder attachment 134, a leveling cylinder 136, a leveling plate 138, and a plurality of guides 140.

The plurality of bosses 132 provides a pivot connection between the tool adaptor 20 and the extending arms 110. The tilt cylinder attachment 134 connects the tool adaptor 20 to the tilt cylinders 114. Thus, as the tilt cylinders 114 are operated as previously described, the tool adaptor 20 is rotated about the connection between the bosses 132 and the extending arms 110.

The leveling plate 138 is secured to the tilt cylinder attachment 134 and the bosses 132. The leveling cylinder 136 is connected at a first end 142 to the leveling plate 138 and at a second end 144 to the plate adaptor 124. Thus, adjusting the length of the leveling cylinder 136 causes the plate adaptor 124 to rotate about the pivot pin 128. The guides 140 are attached to the plate adaptor 124 and adapted to hold the leveling plate 138 in place, while allowing the plate adaptor to rotate about the pivot pin 128.

Various modifications can be made in the design and operation of the present invention without departing from its spirit. Thus, while the principal preferred construction and modes of operation of the invention have been explained in what is now considered to represent its best embodiments, it should be understood that within the scope of the appended claims, the invention may be practiced otherwise than as specifically illustrated and described.

1. A tool carrier machine comprising:
a drive frame undercarriage;
an upper frame having a front end and a back end;
a turret adapted to rotatably connect the upper frame to the undercarriage;
a lift arm apparatus having a first end and a second end, the first end being pivotally connected to the upper frame at a pivot point;
a tool adaptor attachable to the second end of the lift arm apparatus; and
an operator station supported by and substantially centered on the back end of the upper frame, the operator station comprising a platform;
wherein the platform is adapted to allow operation of the machine while standing on the platform.

2. The machine of claim 1, wherein the drive frame undercarriage comprises:
a track frame substructure;
first and second drive tracks, movably supportable on the substructure and adapted to propel the machine.

3. The machine of claim 2, wherein the track frame substructure is adjustable to modify a distance between the first and second drive tracks.

4. The machine of claim 2, wherein the track frame substructure comprises a first drive motor to power the first drive track and a second drive motor to power the second drive track.

5. The machine of claim 2, wherein the track frame substructure comprises a plurality of rollers secured to the substructure, such that the first and second tracks are supported by the rollers.

6. The machine of claim 5, wherein the track frame substructure comprises a plurality of bogie rollers.

7. The machine of claim 1, wherein the upper frame comprises:
a mounting structure, adapted to operatively connect the upper frame to the turret; and
a hydraulic power system.

8. The machine of claim 1, wherein the turret comprises:
a turret frame;
a worm gear, attached to the turret frame; and
a sprocket, adapted to rotate by operation of the worm gear.

9. The machine of claim 8, wherein the turret frame is secured to the undercarriage and wherein the sprocket is connected to the upper frame.

10. The machine of claim 1, wherein the turret is positioned forward of a center point, the center point being equidistant to a front end and a back end of the undercarriage.

11. The machine of claim 1, wherein the turret is capable of at least 180 degree rotation in a clockwise direction and a counterclockwise direction.

12. The machine of claim 1, wherein the lift arm apparatus comprises:
a plurality of lift arms pivotally connected to upper frame at the pivot point; and
a plurality of lift cylinders adapted to raise and lower the lift arms.

13. The machine of claim 12, wherein the pivot point is positioned behind the turret and proximate the operator station.

14. The machine of claim 12, wherein the lift arm apparatus comprises:
extending arms adapted to translate fore and aft along the lift arms; and
extension cylinders operatively connected to the lift arms and the extending arms, the extension cylinders adapted to shorten or lengthen the lift arms.

15. The machine of claim 12, wherein the lift arm apparatus further comprises tilt cylinders adapted to pivot the tool adaptor relative to the lift arms.

16. The machine of claim 14, wherein the extension cylinders are adapted to extend and retract the tool adaptor.

17. The machine of claim 1, further comprising a bucket, attachable to the tool adaptor.

18. The machine of claim 1, wherein a line-of-sight extends from the operator station to the tool adaptor.

19. The machine of claim 1, wherein a remote control is adapted for remote operation of the machine.
